(19) United States
(12) Patent Application Publication
(10) Pub. No.: US 2017/0140433 A1
(43) Pub. Date: May 18, 2017

(54) Dynamic Predictive Analytics For Targeted Advertising

(71) Applicant: AT&T INTELLECTUAL PROPERTY I, LP, Atlanta, GA (US)

(72) Inventor: Raghuraman Gopalan, FREEHOLD, NJ (US)

(21) Appl. No.: 14/943,917

(22) Filed: Nov. 17, 2015

(51) Int. Cl. G06Q 30/02; G06N 5/04

(52) U.S. Cl. CPC G06Q 30/0264; G06N 5/04

(57) ABSTRACT

Aspects of the subject disclosure may include, for example, gathering activity information for a user of a media processor determining time stamps for the activity information, generating a model of future user activity based on the time stamps by extrapolating when future events will be performed by the user, determining recommended media content for the future events, requesting the media files at the recommendation time point for the one of the plurality of media files, storing the media files, and presenting a recommendation to present the media files at the recommendation time point. Other embodiments are disclosed.

### FIELD OF THE DISCLOSURE

The subject disclosure relates to a predicting and storing a time-based advertising.

### BACKGROUND

Conventionally, media processor devices predict viewing preferences for a user. These predictions are usually based on extrapolating from view feedback.

### BRIEF DESCRIPTION OF THE DRAWINGS

Reference will now be made to the accompanying drawings, which are not necessarily drawn to scale, and wherein:

FIG. 1 depicts an illustrative embodiment of a system 100 for predicting future content preferences at future time points;

FIG. 2 depicts an illustrative embodiment of method 200 illustrating system 100 of FIG. 1;

FIG. 3 depicts an illustrative embodiment of a method used in portions of the system described in FIGS. 1 and 2;

FIG. 4 depicts illustrative embodiments of communication systems that provide media services for methods 200 and 300 of FIGS. 2 and 3;

FIG. 5 depicts an illustrative embodiment of a web portal for interacting with the communication systems of for methods 200 and 300 of FIGS. 2 and 3 and system 400 of FIG. 4;

FIG. 6 depicts an illustrative embodiment of a communication device; and

FIG. 7 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for dynamically predicting content for a viewer based on a time profile for the user. Thus, the system can exemplarily predict what the user will want to watch at certain timepoints. In addition, the system can exemplarily preload the content and advertising for the user to be ready to use at the predicted periods of time. Other embodiments are described in the subject disclosure.

One or more aspects of the subject disclosure include gathering, by a system comprising a processor, activity information for a user of a media processor; determining, by the system, time stamps for the activity information; generating, by the system, a model of future user activity based on the time stamps by extrapolating when future events will be performed by the user; determining, by the system, recommended media content for the future events, wherein the recommended media content comprises a plurality of media files corresponding to a recommendation time point for each one of the plurality of media files; requesting, by the system, one of the plurality of media files at the recommendation time point for the one of the plurality of media files; storing, by the system, the one of the plurality of media files; and presenting, by the system, a recommendation to present the one of the plurality of media files at the recommendation time point.

One or more aspects of the subject disclosure include an apparatus that performs gathering activity information for a user of a media processor, determining time stamps for the activity information, generating a model of future user activity based on the time stamps by extrapolating when future events will be performed by the user, determining recommended media content for the future events, wherein the recommended media content comprises a plurality of media files corresponding to a recommendation time point for each one of the plurality of media files, requesting one of the plurality of media files at the recommendation time point for the one of the plurality of media files, storing the one of the plurality of media files, and presenting a recommendation to present the one of the plurality of media files at the recommendation time point.

One or more aspects of the subject disclosure include a machine-readable storage medium that, when executed, performs operations including gathering activity information for a user of a media processor, determining time stamps for the activity information, generating a model of future user activity based on the time stamps by extrapolating when future events will be performed by the user, determining recommended media content for the future events, wherein the recommended media content comprises a plurality of media files corresponding to a recommendation time point for each one of the plurality of media files, requesting one of the plurality of media files at the recommendation time point for the one of the plurality of media files, storing the one of the plurality of media files, and presenting a recommendation to present the one of the plurality of media files at the recommendation time point.

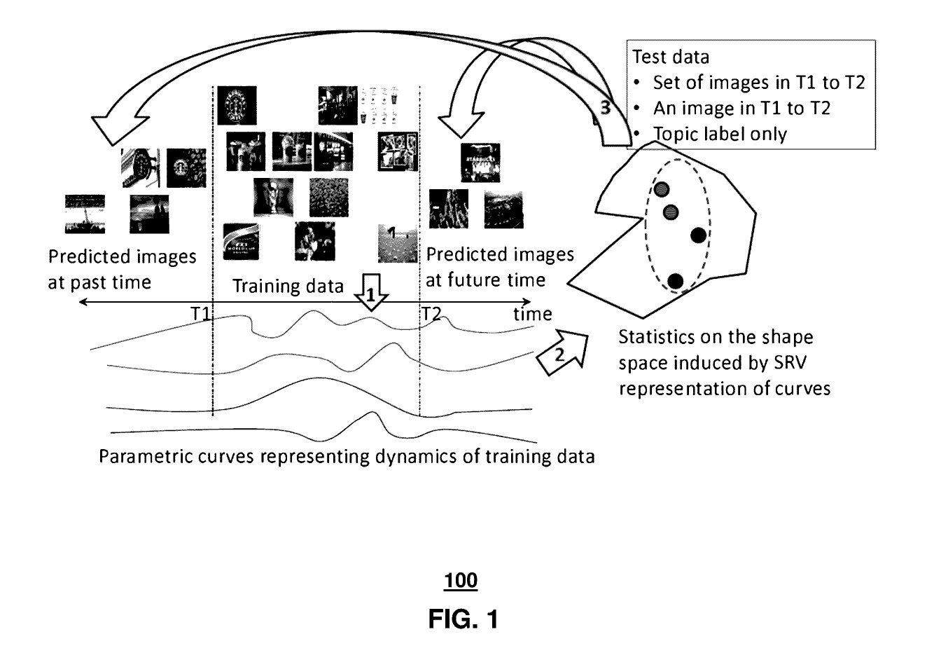

FIG. 1 illustrates an exemplary system 100 in which user input is used to predict content that the user will be interested in future points in time. In this embodiment, FIG. 1 illustrates predicting data for images. In additional embodiments, the data for the predictions can be advertisements, restaurants, movies, places to visit, products, etc.

FIG. 1 illustrates an exemplary system 100 for predicting future content demands. In FIG. 1, training data which may include temporally arranged data that the system already has access to. As illustrated in FIG. 1, this data could be data collected between time instances T1 and T2. Exemplarily, this data is training data.

In FIG. 1, the training data is exemplarily used to create modeling data. The modeling data can include parametric curves representing dynamics. Creating the parametric curves involves modeling of dynamics in the training data in the form of, for example, curves, surfaces, planes etc. in one-, two-, three- and multi-dimensional Hilbert spaces. Thus, as illustrated in FIG. 1, parametric curves represent the dynamics of the training data.

Exemplarily, a shape space/manifold such as a Riemannian manifold corresponding to the space of the curves modeling dynamics is created. In FIG. 1, a SRV (Square root velocity) representation is represented as an instantiation of a Riemannian manifold. Additional examples of other manifolds that are useful for this are Stiefel manifold, Grassmannian manifold, Spherical manifold, etc.

Next, the system would perform statistical learning on the manifold. Exemplarily, the algorithm that models the dynamic curves extracted from training data to perform prediction. The machine learning algorithms respect the geometric structure of the manifold. Examples can include Isomaps, LLE (locally linear embedding), Laplacian Eigenmaps, Hessian Eigenmaps, Karcher means, Kernel discriminant analysis, and manifold vector machines.

Next, the output is generated. Generating the output includes predicting what items should be delivered to the user in the future. Predicted images (future and past)—results of the statistical machine learning algorithm—it tells what images the user would be interested at future time points (and also in past, hypothetically). For ads, it will be what ads to show to user at what time in the future, for products it will be what product the user would be interested at a future time point, for places it will be what potential places the user will visit in the specific future time points etc.

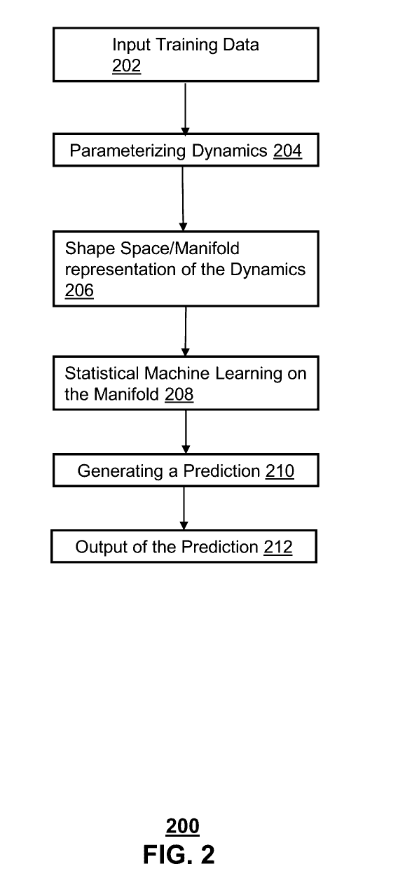

FIG. 2 illustrates an exemplary method 200 that can be used in the system 100 of FIG. 1. In Step 202, training data is exemplarily received. In some embodiments, the training data can be the viewing habits of a user. The times and television programs can be sampled as the training data. As discussed above in FIG. 1, the training data can be data the system has access to between time points T1 and T2, for example.

In Step 204, the training data is parameterized. Parameterizing the data can include modeling of the training data in the form of a curve, a surface, a plane in any number of dimensions. The dimensions can include one, two, three, and multi-dimensional Hilbert spaces. Next, in Step 206, a representation of the data is created. Creating the representation of data can include generating a space shape or a manifold representation of the data. For example, a Riemannian manifold corresponding to the space of the curves modeling dynamics can be generated. In another embodiment, a Square Root Velocity representation can be one instantiation of the Riemannian manifold for the space of curves. Other examples of manifolds that can be used are a Stiefel manifold for orthogonal directions, a Grassmannian manifold for subspaces, and a Spherical manifold for spherical surfaces.

In Step 208, statistical machine learning can be performed on the manifold. Exemplarily, an algorithm that models the dynamic curves extracted from training data can be generated to perform the prediction. The machine learning algorithms exemplarily respect the geometric structure of the manifold. Examples of machine learning algorithms can include Isomaps, Locally Linear Embedding, Laplacian Eigenmaps, Hessian Eigenmaps, Karcher means, Kernel discriminant analysis, and manifold vector machines.

From the statistical machine learning in Step 208, a prediction can be generated in Step 210. Exemplarily, the statistical machine learning can generate data that will indicate what the user would be interested in the future. Additionally, the statistical machine learning can also predict a past model of what the user would have been interested in before the data collection began, provided there is data of what content was available in the past. Exemplarily, the prediction is an output of interest in future time points. The interest in future time points can include media content the user will be interested in watching in the future, at a specific time point. That is, not only is the content predicted but the time at which it will preferred to be watched will be predicted too.

In Step 212, the interest in future time points is output. By outputting the interest in future time points, services can be notified of what and when to deliver to the user. Depending on the embodiment, the output of the interest in future time points can include, for advertising, what advertisements to show to user at what time in the future, for products it will be what product the user would be interested at a future time point, for places it will be what potential places the user will visit in the specific future time points, and for images it shows what photos the user would want to see at different times in the future.

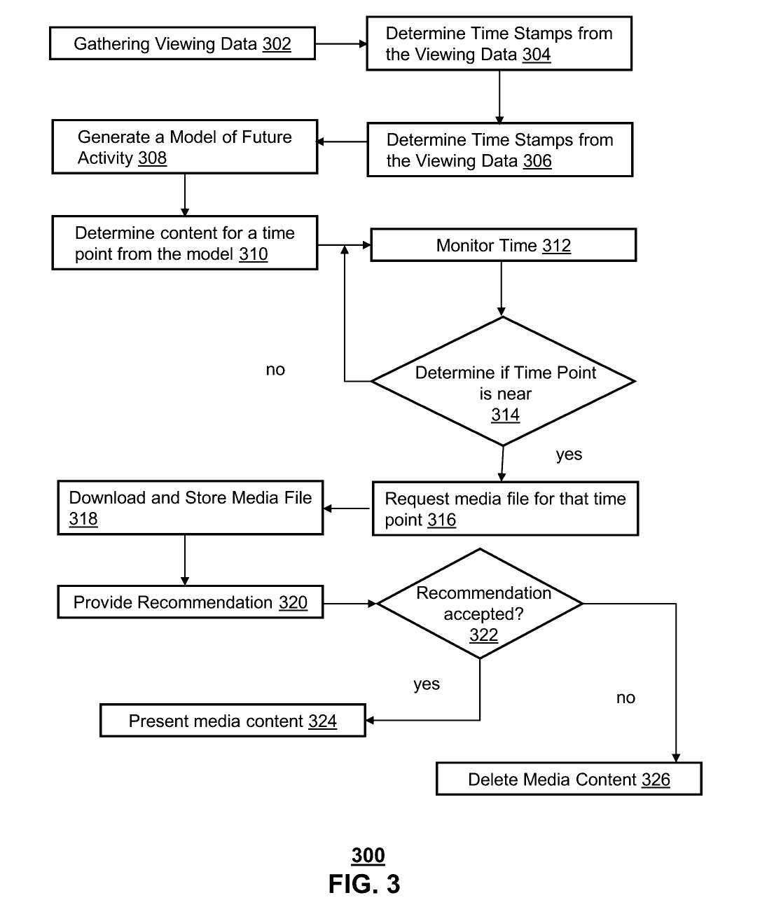

FIG. 3 illustrates an exemplary method that delivers content to a media processor at the predicted point in time. Exemplarily, the media is delivered based on the interest in future time points that includes what types of content the user will want at certain future time points. Exemplarily, as discussed above in FIG. 2, in Step 302, the user's viewing data is collected. In some embodiments, the steps in method 300 can be performed in the user's home by a personal media processor, such as a set-top box. In Step 304, time stamps for the various shows in the viewing data are determined.

In Step 306, a model for future activity, such as generating interest in future time points, is generated. Throughout these steps, these predictions can include other activities that the media processor can exemplarily observe. Thus, for example, if the media processor has access to the user's email information or other communication data, predictions can be generated for who the user would want to contact at a future time point. In addition, the media processor can monitor food orders, for example, to know that at certain future time points, the user will prefer to place a delivery order for food. Thus, method 300 can generate future activities at future time points as well as predicting future content at future time points.

Based on the model for the user's future activity, content and a time frame for the content is generated in Step 310. Once the model future content and future time points are generated, in Step 312, the time is monitored. In, in Step 314, one of the future time points are recognized to be near or approaching, method 300 would advance to Step 316 in which the future media content for the future time point is requested. Otherwise, method 300 would return to the time monitoring step of Step 312. Thus, for example, if in Step 308, the model determines that the user is likely to watch soccer games involving certain teams on Thursdays nights at 8 pm, the media processor can request from a head-end office or other media provider a relevant game to be downloaded onto the media processor to be available at that time. In Step 318, the future content is downloaded to the media processor. That is, the future content is prestored at the media processor as prestored content. Therefore, there can be a lessened load on a server that would otherwise deliver the future content at the predetermined time. In addition, other delays such as download times would be removed as the future content is already stored at the set-top box or other media processor.

In Step 320, a recommendation for the media of the interest in future time points is presented. The recommendation can include a pop-up message on the screen. The recommendation can also include a text message, a phone call, an email, or other methods of contacting the user. For example, the user can be presented with a text message that a soccer game including certain teams is now available for a traditional, for the user, Thursday night viewing.

Of course, in additional embodiments, the steps of method 300 can go beyond predicting media content at future time points. The predictions can include food orders, for example, to know to recommend at Step 320 placing an order for food at a restaurant. The predictions can also include invitations, such as recommending persons to invite to watch the game. The invitation can include an invitation to initiate a virtual viewing session together. The media processor may have access to the user's contact information and history information for the user's various communication devices, including cell-phones, text messages, social media, and email.

In Step 322, it is determined if the recommendations for the future content at the future time point are accepted by the user or not. In Step 324, if the recommendation is accepted, the media content is already available at the media processor, and the delivery thereof can begin at the user's command. In some embodiments, the user may decide to save the recommendation for viewing at a future point in time and thus the content is stored on the media processor for later. On the other hand, in Step 326, if the recommendation is refused by the user, then the prestored content can be deleted.

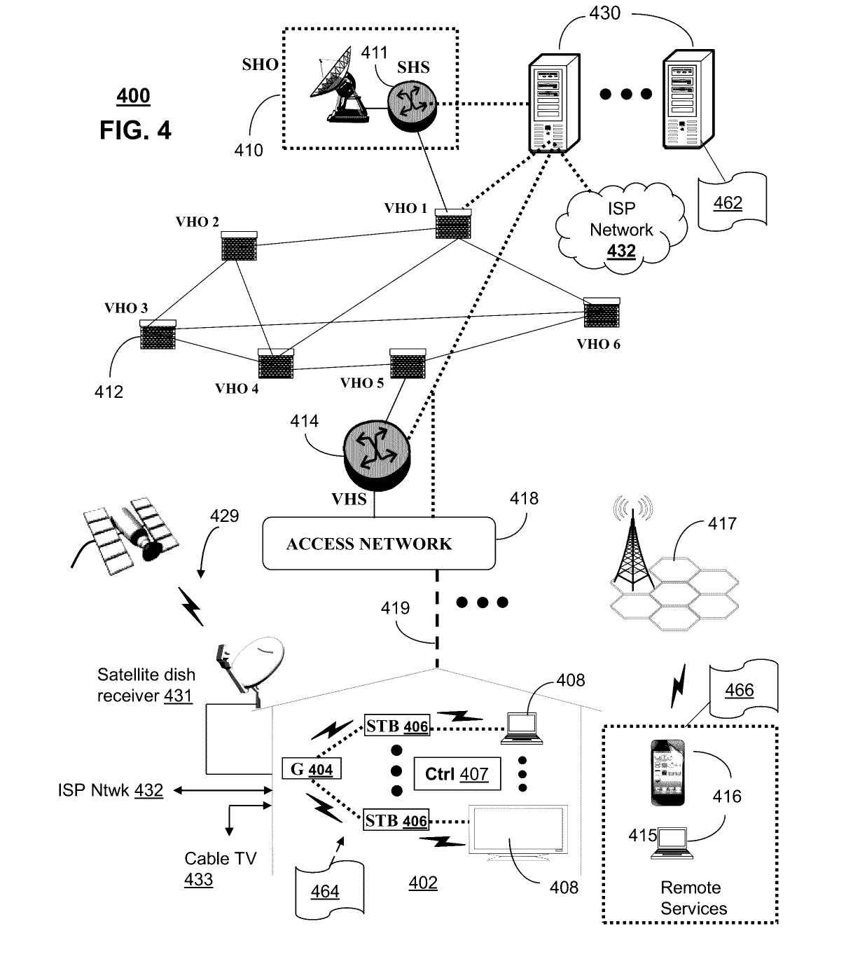

FIG. 4 depicts an illustrative embodiment of a first communication system 400 for delivering media content. The communication system 400 can represent an Internet Protocol Television (IPTV) media system. Communication system 400 can be overlaid or operably coupled with system 100 of FIG. 1 as another representative embodiment of communication system 400. For instance, one or more devices illustrated in the communication system 400 of FIG. 4 can gathering activity information for a user of a media processor determining time stamps for the activity information, generating a model of future user activity based on the time stamps by extrapolating when future events will be performed by the user, determining recommended media content for the future events, wherein the recommended media content comprises a plurality of media files corresponding to a recommendation time point for each one of the plurality of media files, requesting one of the plurality of media files at the recommendation time point for the one of the plurality of media files, storing the one of the plurality of media files, and presenting a recommendation to present the one of the plurality of media files at the recommendation time point.

The IPTV media system can include a super head-end office (SHO) 410 with at least one super headend office server (SHS) 411 which receives media content from satellite and/or terrestrial communication systems. In the present context, media content can represent, for example, audio content, moving image content such as 2D or 3D videos, video games, virtual reality content, still image content, and combinations thereof. The SHS server 411 can forward packets associated with the media content to one or more video head-end servers (VHS) 414 via a network of video head-end offices (VHO) 412 according to a multicast communication protocol.

The VHS 414 can distribute multimedia broadcast content via an access network 418 to commercial and/or residential buildings 402 housing a gateway 404 (such as a residential or commercial gateway). The access network 418 can represent a group of digital subscriber line access multiplexers (DSLAMs) located in a central office or a service area interface that provide broadband services over fiber optical links or copper twisted pairs 419 to buildings 402. The gateway 404 can use communication technology to distribute broadcast signals to media processors 406 such as Set-Top Boxes (STBs) which in turn present broadcast channels to media devices 408 such as computers or television sets managed in some instances by a media controller 407 (such as an infrared or RF remote controller).

The gateway 404, the media processors 406, and media devices 408 can utilize tethered communication technologies (such as coaxial, powerline or phone line wiring) or can operate over a wireless access protocol such as Wireless Fidelity (WiFi), Bluetooth®, Zigbee®, or other present or next generation local or personal area wireless network technologies. By way of these interfaces, unicast communications can also be invoked between the media processors 406 and subsystems of the IPTV media system for services such as video-on-demand (VoD), browsing an electronic programming guide (EPG), or other infrastructure services.

A satellite broadcast television system 429 can be used in the media system of FIG. 4. The satellite broadcast television system can be overlaid, operably coupled with, or replace the IPTV system as another representative embodiment of communication system 400. In this embodiment, signals transmitted by a satellite 415 that include media content can be received by a satellite dish receiver 431 coupled to the building 402. Modulated signals received by the satellite dish receiver 431 can be transferred to the media processors 406 for demodulating, decoding, encoding, and/or distributing broadcast channels to the media devices 408. The media processors 406 can be equipped with a broadband port to an Internet Service Provider (ISP) network 432 to enable interactive services such as VoD and EPG as described above.

In yet another embodiment, an analog or digital cable broadcast distribution system such as cable TV system 433 can be overlaid, operably coupled with, or replace the IPTV system and/or the satellite TV system as another representative embodiment of communication system 400. In this embodiment, the cable TV system 433 can also provide Internet, telephony, and interactive media services. System 400 enables various types of interactive television and/or services including IPTV, cable and/or satellite.

The subject disclosure can apply to other present or next generation over-the-air and/or landline media content services system.

Some of the network elements of the IPTV media system can be coupled to one or more computing devices 430, a portion of which can operate as a web server for providing web portal services over the ISP network 432 to wireline media devices 408 or wireless communication devices 416.

Communication system 400 can also provide for all or a portion of the computing devices 430 to function as prediction engine (herein referred to as prediction engine 430). The prediction engine 430 can use computing and communication technology to perform function 462, which can include among other things, statistical machine learning and prediction of future time and future content techniques described by method 200 of FIG. 2. The media processors 406 and wireless communication devices 416 can be provisioned with software functions 464 and 466, respectively, to utilize the services of prediction engine 430. For instance, functions 464 and 466 of media processors 406 and wireless communication devices 416 can be similar to the functions described monitoring time and requesting media content of FIG. 3 in accordance with method 300.

Multiple forms of media services can be offered to media devices over landline technologies such as those described above. Additionally, media services can be offered to media devices by way of a wireless access base station 417 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure.

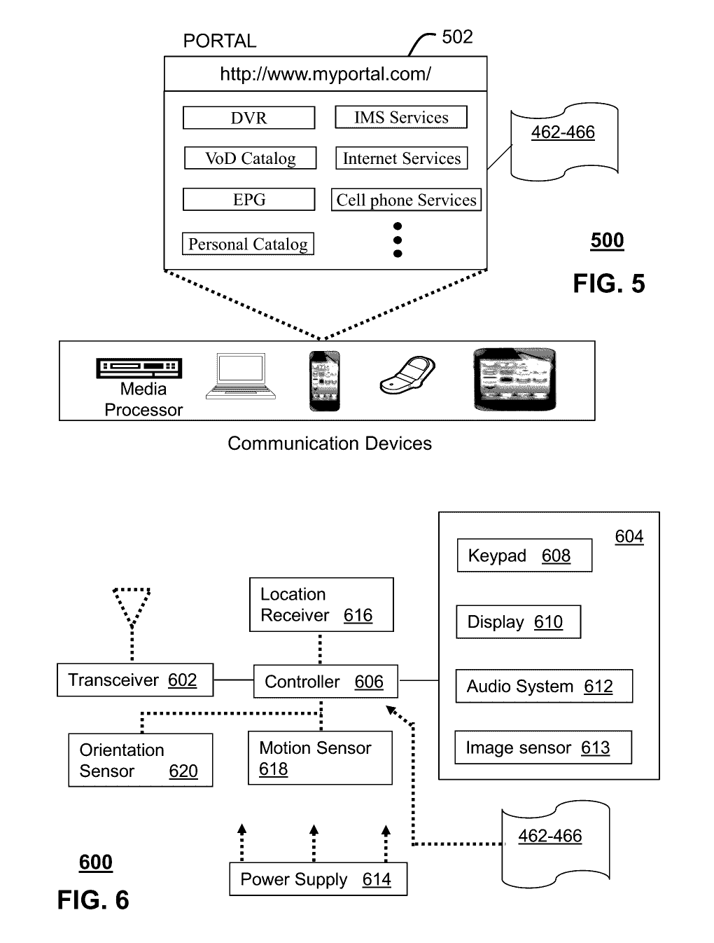

FIG. 5 depicts an illustrative embodiment of a web portal 502 of a communication system 500. Communication system 500 can be overlaid or operably coupled with system 100 of FIG. 1 and communication system 400 as another representative embodiment of system 100 of FIG. 1 and communication system 400. The web portal 502 can be used for managing services of system 100 of FIG. 1 and communication system 400. A web page of the web portal 502 can be accessed by a Uniform Resource Locator (URL) with an Internet browser using an Internet-capable communication device such as those described in FIGS. 1 and 4. The web portal 502 can be configured, for example, to access a media processor 406 and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 406. The web portal 502 can also be used for provisioning IMS services described earlier, provisioning Internet services, provisioning cellular phone services, and so on.

The web portal 502 can further be utilized to manage and provision software applications 464-466 to adapt these applications as may be desired by subscribers and/or service providers of system 100 of FIG. 1 and communication system 400. For instance, users of the services provided by prediction engine 430 can log into their on-line accounts and provision the prediction engine 430 with information regarding their preferences, such as a recommendation delivery method, and so on. Service providers can log onto an administrator account to provision, monitor and/or maintain the system 100 of FIG. 1 or prediction engine 430.

FIG. 6 depicts an illustrative embodiment of a communication device 600. Communication device 600 can serve in whole or in part as an illustrative embodiment of the devices depicted in FIG. 1 and FIG. 4 and can be configured to perform portions of method 200 and 300 of FIGS. 2 and 3, such as generating predictions for future content and future time points and delivering the future content at or before the future time points.

Communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface with graphical user interface (GUI) elements that can be selected by a user with a touch of a finger. The touch screen display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable applications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a reset button (not shown). The reset button can be used to reset the controller 606 of the communication device 600. In yet another embodiment, the communication device 600 can also include a factory default setting button positioned, for example, below a small hole in a housing assembly of the communication device 600 to force the communication device 600 to re-establish factory settings. In this embodiment, a user can use a protruding object such as a pen or paper clip tip to reach into the hole and depress the default setting button. The communication device 600 can also include a slot for adding or removing an identity module such as a Subscriber Identity Module (SIM) card. SIM cards can be used for identifying subscriber services, executing programs, storing subscriber data, and so forth.

The communication device 600 as described herein can operate with more or less of the circuit components shown in FIG. 6. These variant embodiments can be used in one or more embodiments of the subject disclosure.

The communication device 600 can be adapted to perform the functions of a set-top box or server that performs the operations of methods 200 and 300 of FIGS. 2 and 3, the media processor 406, the media devices 408, or the portable communication devices 416 of FIG. 4. It will be appreciated that the communication device 600 can also represent other devices that can operate in system 100 of FIG. 1 and communication system 400 of FIG. 4, such as a gaming console, a set-top box, and a media player. In addition, the controller 606 can be adapted in various embodiments to perform the functions 464 and 466, respectively.

Upon reviewing the aforementioned embodiments, it would be evident to an artisan with ordinary skill in the art that said embodiments can be modified, reduced, or enhanced without departing from the scope of the claims described below. For example, other activities of the user or multiple-users can be monitored to predict other types of future acts at future time points. In addition, other exemplary embodiments can be used to recreate past actions by the user by projecting the model back in time before the observations took place. In other embodiments, the future actions at future time points can lead to food deliveries, reservations at restaurants or hotels, as well as recommending travel options, in addition to other observable activities. In one or more embodiments, the prediction of future user activity and/or desired future content may be performed with or without user intervention or user input. In one or more embodiments, activity of other users can be used as a factor in determining a model of future user activity and/or determining recommended media content for future events. For instance, consumption of the other users can be monitored and a future event (e.g., planned meeting) determined where the user and the other users may want to discuss particular media content. In this example, a recommendation for consuming particular content prior to the future event may be made by the system. Other embodiments can be used in the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

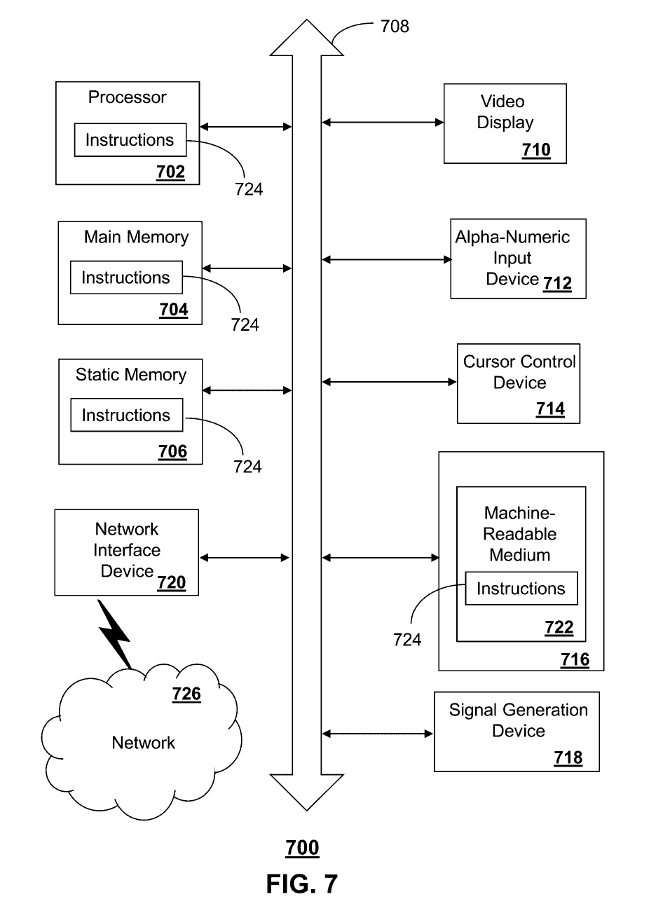

FIG. 7 depicts an exemplary diagrammatic representation of a machine in the form of a computer system 700 within which a set of instructions, when executed, may cause the machine to perform any one or more of the methods described above. One or more instances of the machine can operate, for example, as the prediction engine 430, the media processor 406 and other devices and methods of FIGS. 1-6. In some embodiments, the machine may be connected (e.g., using a network 726) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 700 may include a processor (or controller) 702 (e.g., a central processing unit (CPU)), a graphics processing unit (GPU, or both), a main memory 704 and a static memory 706, which communicate with each other via a bus 708. The computer system 700 may further include a display unit 710 (e.g., a liquid crystal display (LCD), a flat panel, or a solid state display). The computer system 700 may include an input device 712 (e.g., a keyboard), a cursor control device 714 (e.g., a mouse), a disk drive unit 716, a signal generation device 718 (e.g., a speaker or remote control) and a network interface device 720. In distributed environments, the embodiments described in the subject disclosure can be adapted to utilize multiple display units 710 controlled by two or more computer systems 700. In this configuration, presentations described by the subject disclosure may in part be shown in a first of the display units 710, while the remaining portion is presented in a second of the display units 710.

The disk drive unit 716 may include a tangible computer-readable storage medium 722 on which is stored one or more sets of instructions (e.g., software 724) embodying any one or more of the methods or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 722 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 700.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
gathering, by a system comprising a processor, activity information for a user of a media processor;
determining, by the system, time stamps for the activity information;
generating, by the system, a model of future user activity based on the time stamps by extrapolating when future events will be performed by the user;
determining, by the system, recommended media content for the future events, wherein the recommended media content comprises a plurality of media files corresponding to a recommendation time point for each one of the plurality of media files;
requesting, by the system, one of the plurality of media files at the recommendation time point for the one of the plurality of media files;
storing, by the system, the one of the plurality of media files; and
presenting, by the system, a recommendation to present the one of the plurality of media files at the recommendation time point.

2. The method of claim 1, further comprising:
receiving, responsive to the presenting the recommendation, a response to the recommendation; and
presenting the one of the plurality of media files responsive to receiving an affirmative response to the recommendation.

3. The method of claim 2, further comprising deleting the one of the plurality of media files after the presenting or after receiving a negative response to the recommendation.

4. The method of claim 1, wherein the generating of the model of future user activity is based upon Riemannian geometric modeling to predict a dynamic evolution of content based on the time stamps.

5. The method of claim 1, wherein the media processor comprises a set-top box.

6. The method of claim 1, further comprising identifying the user as an identified viewer and determining the time stamps for the identified viewer.

7. The method of claim 1, wherein the presenting the recommendation is performed via one of a text message, an email, a pop-up display, and a tone.

8. An apparatus, comprising:
a processor; and
a memory that stores executable instructions that, when executed by the processor, facilitate performance of operations, comprising:
gathering activity information for a user of a media processor;
determining time stamps for the activity information;
generating a model of future user activity based on the time stamps by extrapolating when future events will be performed by the user;
determining recommended media content for the future events, wherein the recommended media content comprises a plurality of media files corresponding to a recommendation time point for each one of the plurality of media files;
requesting one of the plurality of media files at the recommendation time point for the one of the plurality of media files;
storing the one of the plurality of media files; and
presenting a recommendation to present the one of the plurality of media files at the recommendation time point.

9. The apparatus of claim 8, wherein the operations further comprise:
receiving, responsive to the presenting the recommendation, a response to the recommendation; and
presenting the one of the plurality of media files responsive to receiving an affirmative response to the recommendation.

10. The apparatus of claim 9, wherein the operations further comprise deleting the one of the plurality of media files after the presenting or after receiving a negative response to the recommendation.

11. The apparatus of claim 8, wherein the generating of the model of future user activity is based upon Riemannian geometric modeling to predict a dynamic evolution of content based on the time stamps.

12. The apparatus of claim 8, wherein the media processor comprises a set-top box.

13. The apparatus of claim 8, wherein the operations further comprise identifying the user as an identified viewer and determining the time stamps for the identified viewer.

14. The apparatus of claim 8, wherein the presenting the recommendation is performed via one of a text message, an email, a pop-up display, and a tone.

15. A machine-readable storage medium, comprising executable instructions that, when executed by a processor, facilitate performance of operations, comprising:
gathering activity information for a viewer of a media processor;
determining time stamps for the activity information;
generating a model of future user activity based on the time stamps by extrapolating when future events will be performed by the user;
determining recommended media content for the future events, wherein the recommended media content comprises a plurality of media files corresponding to a recommendation time point for each one of the plurality of media files;
requesting one of the plurality of media files at the recommendation time point for the one of the plurality of media files;
storing the one of the plurality of media files; and
presenting a recommendation to present the one of the plurality of media files at the recommendation time point.

16. The machine-readable storage medium of claim 15, further comprising:
receiving, responsive to the presenting the recommendation, a response to the recommendation; and
presenting the one of the plurality of media files responsive to receiving an affirmative response to the recommendation.

17. The machine-readable storage medium of claim 16, further comprising deleting the one of the plurality of media files after the presenting or after receiving a negative response to the recommendation.

18. The machine-readable storage medium of claim 15, wherein the generating of the model of future user activity is based upon Riemannian geometric modeling to predict a dynamic evolution of content based on the time stamps.

19. The machine-readable storage medium of claim 15, further comprising identifying the viewer as an identified viewer and determining the time stamps for the identified viewer.

20. The machine-readable storage medium of claim 15, wherein the presenting the recommendation is performed via one of a text message, an email, a pop-up display, and a tone.
